(19) United States
(12) Patent Application Publication
(10) Pub. No.: US 2023/0108029 A1
(43) Pub. Date: Apr. 6, 2023

(54) DRIVER ASSISTANCE FOR RECHARGING OF MULTIPLE BATTERY UNITS IN ELECTRIFIED VECHICLE AND TRAILER

(71) Applicant: FORD GLOBAL TECHNOLOGIES, LLC, Dearborn, MI (US)

(72) Inventors: Stuart C. Salter, White Lake, MI (US); Ryan O'Gorman, Beverly Hills, MI (US); Lorne M. Forsythe, Novi, MI (US); Peter Phung, Windsor (CA); Darrel A. Recker, Ypsilanti, MI (US); John R. Van Wiemeersch, Novi, MI (US)

(21) Appl. No.: 17/493,027

(22) Filed: Oct. 4, 2021

(51) Int. Cl. B60W 50/14; B60L 53/66; B60K 1/04

(52) U.S. Cl. CPC B60W 50/14; B60L 53/66; B60K 1/04; B60W 2050/146; B60K 2001/0444; B60K 2001/0416

(57) ABSTRACT

Battery-powered electrified vehicles towing one or more trailers carrying additional rechargeable batteries results in a multi-battery system for which the act of charging the batteries becomes more challenging. A vehicle driver assistance system hereof aids a driver for identifying recharging stations meeting a desired recharging objective for the combined vehicle/trailer having a main battery and a secondary battery to be recharged. The system guides the driver to a parking location and provides instructions for obtaining a hookup to a recharging station.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to aiding a driver in recharging an electrified vehicle with a multi-battery system, and, more specifically, to a vehicle driver assistance system for identifying recharging stations meeting a desired recharging objective for an electrified vehicle towing a trailer having a secondary rechargeable battery and for guiding the driver to a parking location and obtaining a hookup for recharging.

The level of battery capacity conventionally available on electrified vehicles has led to challenges in providing sufficiently long driving distances (i.e., driving range) before needing to be recharged. In addition to providing adequate driving range, it is desirable that when an electric vehicle is recharged that the time required to reach a desired state of charge be kept short.

Improvements in electrified vehicles have enabled them to be employed in many types of vehicle usage applications, such as towing trailers for expanded cargo capacity or for camping. Such trailers may include supplemental batteries to supply electrical power for use by electrical devices in the trailer and/or as supplemental power for the towing vehicle. In addition, trailers can also be deployed with the sole purpose of providing a secondary battery to supply power to the electrified vehicle which results in extending the driving range before a recharge is needed.

Undertaking a recharging operation while towing a trailer having a secondary battery which will also be recharged leads to added considerations such as 1) the need for a layout at a charging station that accommodates the length of a combined vehicle and trailer, 2) the need for a placement of chargers which can reach the charge ports of the vehicle and trailer, 3) availability of chargers that can deliver charging rates meeting the requirements of the driver, 4) checking for the availability of recharging time at a charging station which is able to accommodate the vehicle/trailer combination and charging objectives, and 5) navigating the vehicle and trailer into a corresponding parking spot once a charging station has been selected. Some vehicles or trailers may have more than one usable charge port or may have multiple charging modes (e.g., charging rates and/or the ability to pass through a charging current to another battery unit, such as from the vehicle to the trailer-mounted battery). Because of the large number of interacting options, it becomes difficult for the driver to easily and conveniently select and implement an optimal recharging task.

### SUMMARY OF THE INVENTION

In one aspect of the invention, an electrified vehicle comprises a rechargeable onboard battery unit storing electrical power for a traction motor used to move the vehicle. A main charge port is configured to couple the onboard battery unit to chargers at fixed charging stations. A controller is coupled to the onboard battery unit and configured to communicate with controllers installed in one or more trailer-mounted battery units, wherein the trailer-mounted battery units have one or more secondary charge ports. At least one sensor is configured to characterize a position of the electrified vehicle relative to a plurality of chargers at the fixed charging stations. The controller is configured to i) identify a current multi-battery setup including positioning of charge ports and corresponding charging rates, ii) elicit a user selected charging objective relating to the onboard battery unit and the one or more trailer-mounted battery units, iii) access a database of available charging stations and their associated layouts, iv) identify one or more charging scenarios within the available charging stations which satisfy the charging objective, v) elicit a user selected confirmation of one of the charging scenarios, vi) guide the vehicle to a parking location matching the charging scenario where a hookup to at least one charging station of the confirmed charging scenario can be achieved, and vii) communicate instructions to a user for completing the hookup.

In another aspect of the invention, a method is provided for recharging an electrified vehicle which is towing one or more trailer-mounted battery units with secondary charge ports, wherein the vehicle includes a rechargeable onboard battery unit storing electrical power for a traction motor used to move the vehicle with a main charge port configured to couple the onboard battery unit to chargers at fixed charging stations, and wherein the vehicle includes at least one sensor configured to characterize a position of the electrified vehicle relative to a plurality of chargers at the fixed charging stations. The method includes i) identifying a current multi-battery setup including positioning of charge ports and corresponding charging rates, ii) eliciting a user selected charging objective relating to the onboard battery unit and the one or more trailer-mounted battery units, iii) accessing a database of available charging stations and their associated layouts, iv) identifying one or more charging scenarios within the available charging stations which satisfy the charging objective, v) eliciting a user selected confirmation of one of the charging scenarios, vi) guiding the vehicle to a parking location matching the charging scenario where a hookup to at least one charging station of the confirmed charging scenario can be achieved, and vii) communicating instructions to a user for completing the hookup.

### BRIEF DESCRIPTION OF THE DRAWINGS

FIG. 1 is a schematic view of an electrified vehicle towing a serial arrangement of two trailers carrying secondary battery units.

FIG. 2 is a schematic view of an example layout of a charging station.

FIG. 3 is an overhead view of a charging station layout having pull-through lanes to accommodate longer vehicles.

FIG. 4 is an overhead view of an electrified vehicle towing two trailers with secondary batteries, wherein selected charge ports have been connected to rechargers of the charging station according to a first scenario.

FIG. 5 is an overhead view of an electrified vehicle towing two trailers with secondary batteries, wherein selected charge ports have been connected to rechargers of the charging station according to a second scenario.

FIG. 6 is an overhead view of an electrified vehicle towing two trailers with secondary batteries, wherein selected charge ports have been connected to rechargers of the charging station according to a third scenario.

FIG. 7 is an overhead view of an electrified vehicle towing a trailer with a secondary battery, wherein selected charge ports have been connected to rechargers of the charging station according to a fourth scenario.

FIG. 8 is a schematic, block diagram showing a vehicle, trailer, charging station, and network resources according to an embodiment of the invention.

FIG. 9 is a flowchart showing one preferred method according to the invention.

### DETAILED DESCRIPTION OF PREFERRED EMBODIMENTS

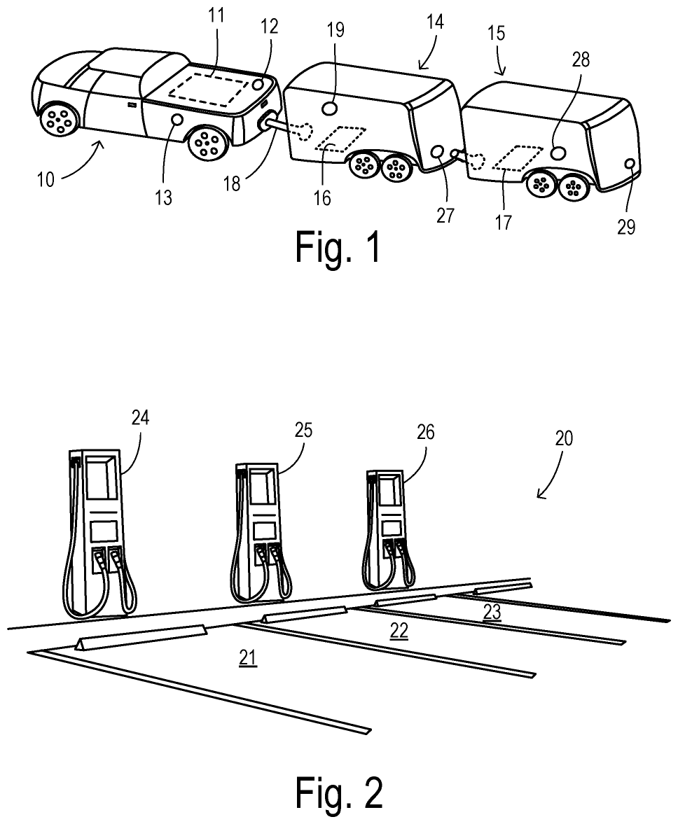

FIG. 1 shows an electrified vehicle 10 (often referred to as a battery-electric vehicle or BEV) configured as an electric pickup truck. Vehicle 10 has an onboard rechargeable battery unit 11 which stores electrical power for a traction motor (not shown) to propel vehicle 10. The traction motor may comprise an electric machine mechanically coupled to a gearbox which may include a differential. The electric machine may also act as a generator during deceleration to recover energy that would normally be lost as heat in a friction braking system.

Battery unit 11 may be comprised of a multi-cell which provides a high voltage, direct current (DC) output. A contactor module may selectably connect battery unit 11 with a high-voltage bus (not shown). A power electronics module (not shown) controls operation of the electric machine and provides the ability to bi-directionally transfer energy between battery unit 11 and the electric machine. The power electronics module may convert the DC voltage to a three-phase AC current to operate the electric machine. In a regenerative mode, the power electronics module may convert the three-phase AC current from the electric machine acting as a generator to a DC voltage for recharging battery unit 11.

Vehicle 10 is configured to recharge battery unit 11 from external power sources using one or more charge ports 12 and 13. External power sources may include electrical outlets at private or public locations. Electric vehicle supply equipment (EVSE) for connecting to a vehicle's charging port may include a charger unit at a charging station (i.e., a location having parking stalls or spaces each provided with one or more charger units). A charging station serving a plurality of electrified cars and trucks may be connected to an electrical power distribution network or grid as provided by an electric utility company and may be managed by electronic control systems enabling users to reserve a time period and charger outlet for their use, as described in patent application publication US 2020/0148068A1 and in patent U.S. Pat. No. 11,001,161, which are both incorporated herein by reference. FIG. 2 shows a charging station 20 having parking spaces 21-23 which each has a respective charger unit 24-26, respectively, arranged for use by electric vehicles parked in the spaces.

The EVSE and control systems of the charging station may regulate and manage the transfer of energy between power source and vehicle 10. Charge ports 12 and 13 may be any type of port configured to transfer power from EVSE to vehicle 10. In some embodiments, charge ports 12 and 13 may be electrically coupled to an on-board power conversion module which provides proper voltage and current levels to battery unit 11. An EVSE connector may have pins that mate with corresponding recesses of charge port 12 or 13. Alternatively, various components described as being electrically coupled or connected may transfer power using a wireless inductive coupling. The use of EVSE for charging BEV batteries is described in patent application publication US 2020/0369168A1, which is incorporated herein by reference.

Returning to FIG. 1, vehicle 10 is hitched together with trailers 14 and 15 which include respective battery units 16 and 17. The use of trailers 14 and/or 15 may be primarily for the purpose of carrying additional battery capacity for vehicle 10, in which case a trailer hitch 18 may provide both mechanical and electrical connections. In addition to the extra battery capacity, trailers 14 and/or 15 may additionally provide a supplemental cargo space. With or without providing supplemental battery power to vehicle 10, trailers 14 and/or 15 could be configured as a camper or other functional unit which uses the trailer battery to power trailer-mounted devices (e.g., electrical appliances). For charging trailer-mounted battery units 16 and 17, trailer charge ports 19 and 27 are coupled to battery unit 16 and trailer charge ports 28 and 29 are coupled to battery unit 17.

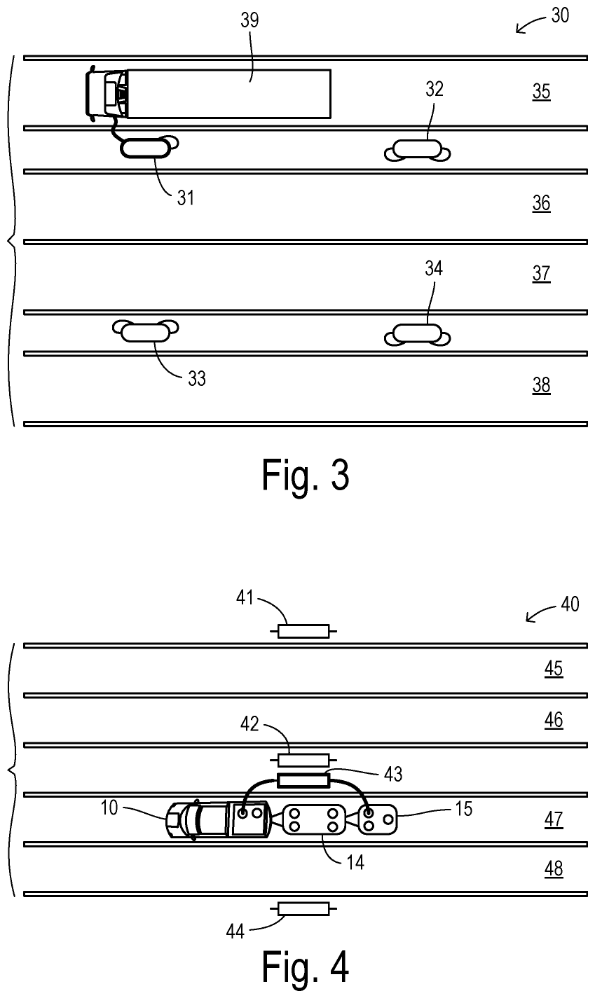

FIG. 3 shows a pull-through layout of a charging station 30 having charging outlets 31-34 deployed adjacent a plurality of pull-through lanes 35-38. A tractor-trailer truck 39 is shown with a single connection to charger unit 31. FIGS. 4-6 show another charging station 40 with multiple charger units 41-44 deployed adjacent a plurality of pull-through lanes 45-48. At any particular time when a driver wishes to visit a charging station for recharging one or more battery units, many potential stations each having distinct layouts, capabilities, and cost may be available within an acceptable distance of a route being traveled. Due to the complexity of the available options, a large number of potential charging scenarios may become available for consideration such that it becomes difficult for a driver to identify an optimal selection.

Even considering just one charging station location, many different charging scenarios may be possible. FIG. 4 shows an example of a charging scenario wherein vehicle 10 is parked in pull-through lane 47 at charging station 40. Depending on the state of charge (SOC) of battery units within vehicle 10, trailer 14, and trailer 15, the driver may indicate a charging objection with respect to a desired charge level to be obtained for each. Charging cables from charger unit 43 are connected to specified charge ports on vehicle 10 and trailer 15. In this example, a battery unit in trailer 14 may also be charged using a passthrough capability of vehicle 10.

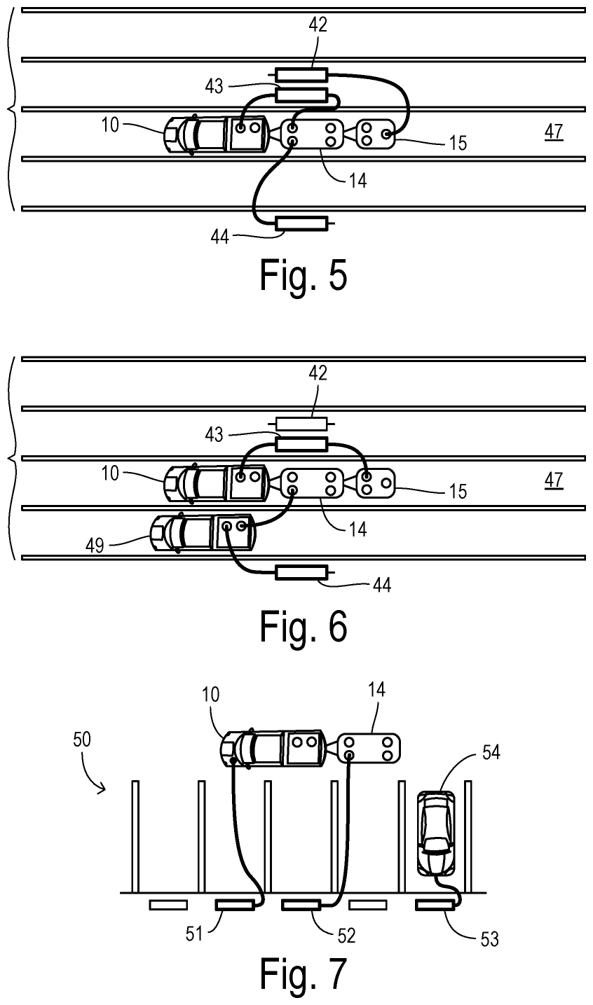

FIG. 5 depicts a charging scenario wherein vehicle 10 is parked in pull-through lane 47 with respective charge ports of vehicle 10 and trailer 14 connected to cables from charger unit 43. A cable from charger unit 42 is connected to a charge port of trailer 15, and a second charge port of trailer 14 is connected to a cable from charger unit 44. In this scenario, a shorter charging time can be obtained consistent with a driver's objectives by tapping into a greater charger capacity.

FIG. 6 depicts another charging scenario with vehicle 10 parked in pull-through lane 47. Charging cables from charger unit 43 are connected to specified charge ports on vehicle 10 and trailer 15. In this example, a battery unit in trailer 14 may also be charged using power delivered by or through a second vehicle 49 (e.g., a vehicle engaged in a service business model in which vehicles share charge with one another for reimbursement). Vehicle 49 is further connected to a cable from charger unit 44.

Given the presence of multiple charge ports on both the vehicle and the trailer, variations in stall/charger layouts and charger power capacities, and variations in the lengths of charger cables, there would usually be a lot of ways that charging could be configured in order to achieve faster charging. An important aspect of the invention is to enable the user to select the charger configuration they want from available charger reservation times and the acceptable duration of a charging event which meets their charge goal.

In certain embodiments of the invention, a driver or other user of an electrified vehicle who is monitoring the states of charge of the multiple batteries units in the vehicle and trailer(s) may determine that a stop at a charging station is desirable. Such a decision may be based on their planned journey, distance-to-empty, and other factors. When trailer-mounted battery units are available to provide supplemental power for either recharging the onboard battery unit or to provide power directly to the vehicle traction drive system, then the driver may first select to rely on the supplemental power. Availability of supplemental power can extend the search range when looking for a recharge. Corresponding recharging scenarios can target charging stations which are at a greater distance and all the battery units can still be recharged as required once the driver reaches the selected charging facility. These scenarios would be especially helpful when there are no nearby charging stations or all the outlets at nearby charging stations are already occupied.

In some instances, certain aspects of a desired objective may be unavailable. Consequently, the driver assistance system may present best available solutions to the driver for selection. For example, a charging station having pull-through lanes might not be discovered within an acceptable distance of the vehicle route. As shown in FIG. 7, a scenario may instead be presented which uses a charging station 50 with single entry/exit parking stalls which are too short to accommodate a vehicle and trailer. Charger units 51, 52, and 53 are at one end of the stalls. A vehicle 54 is shown parked in a stall and being charged by charger unit 53. Because of the maneuvering limitations of the vehicle/trailer combination, the best scenarios that can be presented to the driver have vehicle 10 and trailer 14 positioned across (e.g., blocking) several stalls. Analysis of any such potential charging scenario takes into account availability of cables having sufficient length to reach the intended charge ports from charger units 51 and 52 (e.g., the cables which are installed on the charger units or extension cables which are known to be present in vehicle 10 or trailer 14). The blocking of stalls not being used by vehicle 10 or trailer 14 may be acceptable even when other BEVs are parked in the blocked stalls if they are scheduled to remain in the stall for a known period which is longer than the blocking will be present.

Many more charging scenarios may potentially be available in any particular situation, and even after the driver assistance system has obtained appropriate reservations for charger units and the vehicle has been guided into a parking position which enables a scenario to proceed, the actual hooking up or charge ports to charger units may not be obvious to the driver. Charger units may be available at various power capacities, such as 8 KW to 350 KW. Some vehicles may have passthrough charge capabilities (e.g., daisy-chain configurations for charge balancing between multiple battery units in the vehicle and/or in an attached trailer). In some battery electric vehicles, the number of included charge ports may be as many as eight in order to accommodate different styles of charge capacities of charging outlets and to enable connection to multiple outlets at once for larger battery units. Similarly, any attached trailers may have several charge ports with different respective configurations or power capacity. Thus, determining which charge ports to use, where exactly to park the vehicle/trailer combination adjacent the charger units to be used, and how to make the necessary cable connections and initiate a charging sequence can become a very complex task for the driver to perform.

A large number of potential charging stations may be present along a planned route and within an acceptable distance, with each station having a number of possible parking arrangements which may or may not be workable with the vehicle/trailer combination. Before selecting a charging station, the driver may want to be sure that a parking position for accessing the charger units will not result in the vehicle or trailer sticking out from a space and blocking an aisle. To evaluate whether any particular parking stall would actually work, the driver would have to know an exact length of the vehicle and trailers, exact charge port locations, placement of charger units, size of parking stops, and a minimum turning radius. Then based on that information the driver would have to decide whether there is enough room to maneuver. Thus, it would be desirable to facilitate the identification and selection of charging scenarios, followed by the provision of simple instructions to execute the charging scenarios. Moreover, it would be desirable to identify the best performing scenarios when none of the available scenarios are able to fully meet the driver's objectives (e.g., duration, location, or cost of the scenarios).

In some embodiments of the invention, a charging station layout (e.g., a plan view), power ratings, cord lengths, availability of open stalls, presence of BLE beacons, and/or other details of potential charging sites are obtained from host services over a wireless network. Vehicle and/or trailer lengths and charge port locations/capacities are identified according to data stored in the vehicle and/or obtained remotely (e.g., based on model IDs of the vehicle/trailers). Analysis can be performed using onboard electronics or using cloud-based resources. For example, details such as turning radius and exact charge port locations can be transmitted to, or calculated by a central server (e.g., operated by a vehicle manufacturer or a driver assistance service). Using a touchscreen of an onboard human machine interface (HMI), the driver may assess charge levels in each of battery units (e.g., main onboard battery unit and secondary battery units in the trailers) and then select their preferred charging goal and or location. Based on the foregoing information, the central server determines one or more scenarios for charging including the associated vehicle/trailer positioning and hookup arrangement. One or more potential scenarios are shown on the touchscreen or other HMI display for presentation to the driver (i.e., user). The driver makes a selection using the HMI. Based on the selected charging scenario, navigation guidance is generated in order to assist the driver in reaching a designated parking space and orientation. Once a close approach to the desired location is detected, the vehicle may begin to monitor the relative position of a targeted charger unit/parking spot using any known navigation techniques, such as A) camera images and machine learning which provides feedback enabling the driver to park at the appropriate spot and/or B) signals from a Bluetooth® Low Energy (BLE) node or a UWB (Ultra Wind-Band) beacon installed in the charger unit.

The automated process to determine the charging scenario may include optimizing the use of any available ability for passthrough charging and/or use of multiple charge ports. In consideration of various data which may be available, such as i) the length of the combined vehicle/trailer, ii) an exact location and type of charge ports to be used, iii) the length of cables extending from target charger units, iv) an ability to use multiple charge ports in parallel, to reach a maximum battery charge rate, v) the type of connectors present on the charger units, and vi) the configuration and/or payment actions to be entered on a charger unit's control interface, an appropriate set of visual or audio instructions are presented to the driver in order to effectuate the charging scenario and achieve the previously specified charging goals.

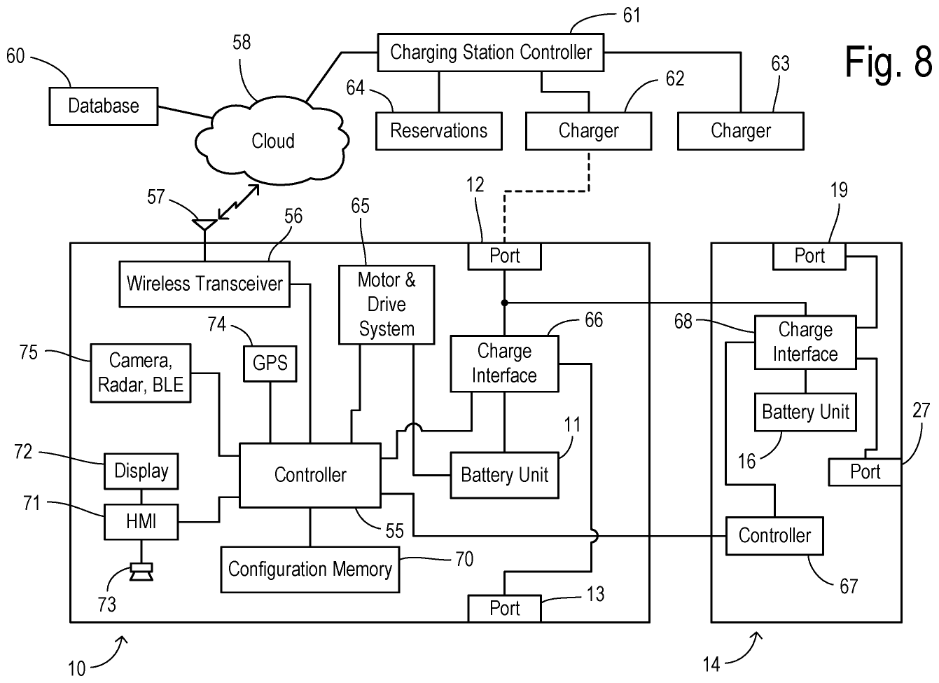

FIG. 8 shows one embodiment of a vehicle, trailer, charging station, and driver assistance system for guiding the selection and implementation of a charging scenario that meets the driver's objectives. Vehicle 10 has a controller 55 which is configured to manage the driver assistance functions associated with identifying, selecting, and implementing charging scenarios as described herein. Controller 55 may communicate with offboard resources using a wireless transceiver 56 and antenna 57. Cellular data communications or other wireless data protocols can be used by transceiver 56 to communicate with a cloud network 58. Offboard resources coupled to cloud network 58 include a database 60 which may be managed by a service provider (e.g., an automobile manufacturer or a service center acting as a clearinghouse for charging stations). Database 60 may store information regarding specifications of battery units installed in various vehicles and/or trailers, charge port configuration data according to various standards, data regarding electric charging stations such as geographic locations, layouts, boundaries of parking spaces, locations and reach of charge cables, and charging capacities. Database 60 and vehicle controller 55 may be in communication via cloud network 58 with a plurality of charging station systems, such as a charging station controller 61 which is associated with one or more charging station locations. Charging station controller 61 communicates directly with charger units including charging unit 62 and charging unit 63 in order to manage charging operations and/or payment functions. A reservations database 64 is coupled with charging station controller 61 to manage requests for schedule usage times of charger units in response to user requests (e.g., received from vehicle controller 55 and/or database 60). At an appointed time, a charge port 12 on vehicle 10 is connected with a charger unit 62 after navigating to the correct position.

Vehicle controller 55 is connected with a charge interface 66 in vehicle 10 which manages operation of the recharging of battery unit 11 via charge ports 12 and 13. Vehicle controller 55 further communicates with a trailer controller 67 which manages a charge interface 68 in trailer 14 connected between battery unit 16 and ports 19 and 27. Charge interfaces 66 and 68 may include inverters and/or power converters to condition power which delivered to the battery units as is known in the art. Interfaces 66 and 68 may include additional known features for providing a charge passthrough between vehicle 10 and trailer 14.

Vehicle 10 includes a motor and drive system 65 coupled to controller 55. Drive system 65 receives electrical power from battery unit 11 in order to generate propulsion for driving vehicle 10. Controller 55 may include a configuration memory 74 storing charging-related data such as the location, dimensions, and specifications of charge ports deployed on vehicle 10, charging rates or capacities associated with charge ports 12 and 13, and identification of any charge passthrough capability of vehicle 10.

For interaction with the driver or other user, controller 55 is coupled with an HMI 71 which preferably includes a touchscreen display 72 and one or more sound transducers 73 which are configured to reproduce audible instructions inside and outside of vehicle 10. Controller 55 is coupled with a GPS system 74 and/or other navigation aids in order to evaluate vehicle routes and to determine charging stations which lie within an acceptable distance of the route or present location of vehicle 10.

For the purpose of obtaining accurate navigation to a target position relative to selected charger unit(s), controller 55 is coupled to a plurality of sensors 75 which may include a camera, a radar system, an ultrasonic sensing system, and/or a BLE beacon receiver and which are configured to characterize a position of the electrified vehicle relative to a plurality of charger units at the fixed charging stations. Sensors 75 may comprise an image sensor, wherein controller 55 is configured to analyze captured images from the image sensor to estimate a path of the electrified vehicle to a desired parking location. Sensors 75 may comprise a radar unit, wherein controller 55 is configured to analyze radar data from the radar unit to estimate a path of the electrified vehicle to the parking location. Sensors 75 may comprise a wireless receiver adapted to receive wireless signals from a fixed transmitter beacon (e.g., BLE beacon) at the charging station, wherein controller 55 is configured to analyze the wireless signals to estimate a path of the electrified vehicle to the parking location.

Battery unit 11 is a rechargeable onboard battery unit which stores electrical power for motor and drive system 65 in order to move vehicle 10 as intended by a driver. Charge ports 12 or 13 may operate as a main charge port configured to couple battery unit 11 to one or more charger units such as charging unit 62 at a fixed charging station. Trailer 14 has a trailer-mounted battery unit 16 with charge ports 19 and 27 operating as secondary charge ports under control of controller 67 which communicates with controller 55.

In operation, either before or after a user indicates a desire to obtain recharging, controller 55 identifies a current multi-battery set up including the positioning of charge ports and corresponding charging rates. Controller 55 elicits a user-selected charging objective relating to the onboard battery unit and the trailer mounted battery unit based on the amount of charge desired (e.g., a target state of charge for one or more battery units), a target charging time available for charging, and/or a limited geographic region for selecting a charging station, for example. The limited geographic region may be determined according to a distance-to-empty (DTE) of the electrified vehicle taking into account the trailer-mounted battery units.

Controller 55 accesses database 60 of available charging stations and their associated layouts. Controller 55 then identifies one or more charging scenarios using the available charging stations which satisfy the charging objective. The charging scenarios may each comprise a vehicle parking location and cable connections to respective charge ports to be made. After presenting available scenarios to the user, the user confirms a selection of one of the charging scenarios. Controller 55 is configured to remotely enroll a reservation for a charging event at a charging station identified in the charging scenario which is confirmed by a user. The reservation may include a selected charger unit(s) with compatible cable plugs and a compatible charging rate(s). Then the driver assistance controller 55 guides the driver by generating appropriate instructions allowing the driver to proceed with the vehicle to a parking location matching the charging scenario where the charge ports can be coupled to at least one charging station (i.e., charger unit) according to the confirmed charging scenario. Once the desired location is reached, controller 55 communicates instructions to the user for completing the corresponding hook up between the vehicle/trailer combination and the charge unit(s).

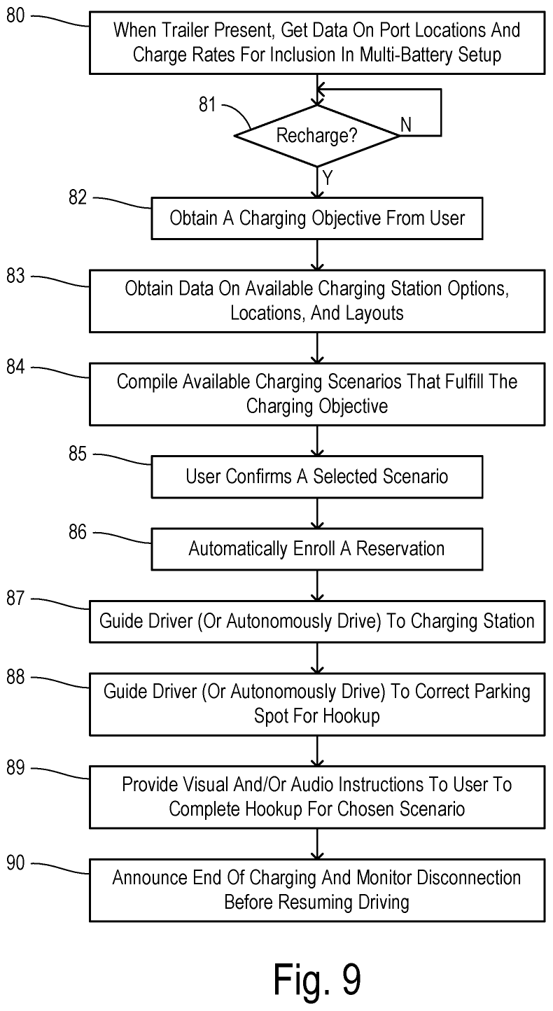

FIG. 9 shows a first embodiment of a method of the invention wherein a battery electric vehicle is operated with a trailer present (having a trailer mounted battery unit). Data on charge port locations and charge rates which are included in the multi-battery setup of a combined vehicle and trailer are obtained (e.g., from onboard configuration memory and/or offboard databases). A check is performed in step 81 to determine whether a user has indicated the need to proceed to a recharging station in order to recharge at least one battery unit. When a recharge has been requested, then a desired charging objective is obtained from the user in step 82. The charging objective may include a target state of charge to be obtained for one or more battery units, a target charging time or window, and/or a limited geographic region in which charging station should be located. The limited geographic region may be defined according to a distance-to-empty (DTE) of the electrified vehicle, taking into account all the available battery units (e.g., primary onboard battery unit and any trailer-mounted battery units).

In order to identify charging scenarios potentially capable of satisfying the charging objective, data on available charging station options, locations, and layouts is obtained in step 83. In step 84, the vehicle controller compiles available charging scenarios that satisfy the charging objective. For example, available reservation times for parking stalls capable of accommodating the maneuvering capability and the length of the vehicle/trailer combination are analyzed together with their charging capacities and other factors to determine which can be used in order to reasonably meet the charging objective.

In step 85, the user confirms a selected scenario from those presented by the vehicle controller on an HMI display screen, for example. Based on the selected scenario, the vehicle controller automatically enrolls a reservation for access to the identified charging station or charger units in step 86. In step 87, the vehicle controller executes actions which guide the driver (or autonomously drive the vehicle) to the selected charging station. Guidance may include turn-by-turn instructions, for example.

Once the vehicle is detected to be in close proximity to the intended charging location (e.g., as determined using a GPS receiver and navigation system), then onboard sensors may be activated in order to ensure accurate placement of the vehicle and trailer at the appropriate position and orientation. Vehicle/trailer placement may be needed at a resolution better than is obtained using GPS navigation since a different of less than a meter can impact the ability of a particular cable to reach the intended charge port. The final placement can be obtained by either providing guidance instructions to the driver or autonomously driving the vehicle and trailer into position in step 88.

With the vehicle call/trailer parked, visual and or audio instructions are provided in step 89 to assist the user in completing a hookup for the chosen charging scenario. For example, specific cable connections between one or more charger units and corresponding vehicle or trailer mounted charging ports are communicated to the user in the form of the display of verbal (textual) instructions, graphic depiction of the connections, and/or verbal (spoken) instructions played over interior and/or exterior speakers. The instructions may ensure that a selected charger unit is connected to a compatible charge port and compatible charging rate. The instructions may include steps for initiating a charge passthrough as appropriate. Once a charging objective has been satisfied in step 90, the vehicle controller may announce the end of charging to the user, and then the vehicle controller may wait for a proper disconnection of the charging cables before allowing the driver to resume driving.

What is claimed is:

1. An electrified vehicle comprising:
a rechargeable onboard battery unit storing electrical power for a traction motor used to move the vehicle;
a main charge port configured to couple the onboard battery unit to chargers at fixed charging stations;
a controller coupled to the onboard battery unit and configured to communicate with controllers installed in one or more trailer-mounted battery units, wherein the trailer-mounted battery units have one or more secondary charge ports; and
at least one sensor configured to characterize a position of the electrified vehicle relative to a plurality of chargers at the fixed charging stations;
wherein the controller is configured to:
identify a current multi-battery setup including positioning of charge ports and corresponding charging rates;
elicit a user selected charging objective relating to the onboard battery unit and the one or more trailer-mounted battery units;
access a database of available charging stations and their associated layouts;
identify one or more charging scenarios within the available charging stations which satisfy the charging objective;
elicit a user selected confirmation of one of the charging scenarios;
guide the vehicle to a parking location matching the user selected charging scenario where a hookup to at least one charging station of the confirmed charging scenario can be achieved; and
communicate instructions to a user for completing the hookup.

2. The electrified vehicle of claim 1 wherein the database stores information representing charging capacity of chargers at the charging stations, boundaries of parking spaces, and locations and reach of charge cables.

3. The electrified vehicle of claim 1 wherein the selected charging objective includes a target state of charge for one or more battery units, a target charging time, or a limited geographic region for selecting a charging station.

4. The electrified vehicle of claim 3 wherein the limited geographic region is determined according to a distance-to-empty (DTE) of the electrified vehicle taking into account the trailer-mounted battery units.

5. The electrified vehicle of claim 1 wherein the charging scenarios each comprise a vehicle parking location and cable connections to respective charge ports.

6. The electrified vehicle of claim 1 wherein the controller is further configured to remotely enroll a reservation for a charging event at a charging station identified in the charging scenario confirmed by a user.

7. The electrified vehicle of claim 6 wherein the reservation includes a selected charger with a compatible cable plug and a compatible charging rate.

8. The electrified vehicle of claim 1 wherein the sensor comprises an image sensor, and wherein the controller is configured to analyze captured images from the image sensor to estimate a path of the electrified vehicle to the parking location.

9. The electrified vehicle of claim 1 wherein the sensor comprises a radar unit, and wherein the controller is configured to analyze radar data from the radar unit to estimate a path of the electrified vehicle to the parking location.

10. The electrified vehicle of claim 1 wherein the sensor comprises a wireless receiver adapted to receive wireless signals from a fixed transmitter at the charging station, and wherein the controller is configured to analyze the wireless signals to estimate a path of the electrified vehicle to the parking location.

11. The electrified vehicle of claim 1 wherein the multi-battery setup comprises a state of charge of the onboard battery unit and the one or more trailer-mounted battery units, and a pass-through charging capability of the onboard battery unit or the trailer-mounted battery units.

12. The electrified vehicle of claim 1 wherein the multi-battery setup comprises a combined length of the vehicle and one or more trailers carrying the one or more trailer-mounted battery units.

13. The electrified vehicle of claim 1 wherein the controller guides the vehicle to the parking location using autonomous vehicle control.

14. The electrified vehicle of claim 1 wherein the controller guides the vehicle to the parking location by providing verbal or pictorial instructions for manual execution by a driver.

15. The electrified vehicle of claim 1 further comprising a human interface unit for eliciting user selections and communicating the instructions for completing the hookup or maneuvering to the parking location.

16. A method of recharging an electrified vehicle which is towing one or more trailer-mounted battery units with secondary charge ports, wherein the vehicle includes a rechargeable onboard battery unit storing electrical power for a traction motor used to move the vehicle with a main charge port configured to couple the onboard battery unit to chargers at fixed charging stations, wherein the vehicle includes at least one sensor configured to characterize a position of the electrified vehicle relative to a plurality of chargers at the fixed charging stations, and wherein the method comprises the steps of:
identifying a current multi-battery setup including positioning of charge ports and corresponding charging rates;
eliciting a user selected charging objective relating to the onboard battery unit and the one or more trailer-mounted battery units;
accessing a database of available charging stations and their associated layouts;
identifying one or more charging scenarios within the available charging stations which satisfy the charging objective;
eliciting a user selected confirmation of one of the charging scenarios;
guiding the vehicle to a parking location matching the user selected charging scenario where a hookup to at least one charging station of the confirmed charging scenario can be achieved; and
communicating instructions to a user for completing the hookup.

17. The method of claim 16 wherein the database stores information representing charging capacity of chargers at the charging stations, boundaries of parking spaces, and locations and reach of charge cables.

18. The method of claim 16 wherein the selected charging objective includes a target state of charge for one or more battery units, a target charging time, or a limited geographic region for selecting a charging station, and wherein the limited geographic region is determined according to a distance-to-empty (DTE) of the electrified vehicle taking into account the trailer-mounted battery units.

19. The method of claim 16 wherein the charging scenarios each comprise a vehicle parking location and cable connections to respective charge ports.

20. The method of claim 16 further comprising the step of remotely enrolling a reservation for a charging event at a charging station identified in the charging scenario confirmed by a user.
